(19) United States
(12) Patent Application Publication
(10) Pub. No.: US 2019/0308341 A1
(43) Pub. Date: Oct. 10, 2019

(54) KIT FOR CONSTRUCTING A STACKABLE COLUMN

(71) Applicant: PLY GEM INDUSTRIES, INC., CARY, NC (US)

(72) Inventors: SCOTT S. OLIVERI, MANTUA, NJ (US); EARL NELSON ROHRER, CHAMBERSBURG, PA (US); DEREK D. ZIMMERMAN, MIFFLINBURG, PA (US)

(21) Appl. No.: 16/375,522

(22) Filed: Apr. 4, 2019

Related U.S. Application Data
(60) Provisional application No. 62/652,402, filed on Apr. 4, 2018.

(51) Int. Cl. B28B 23/02; E04B 1/18; E04C 3/34

(52) U.S. Cl. CPC B28B 23/02; E04C 3/34; E04B 1/18

(57) ABSTRACT

A kit for constructing a stackable column, the kit including at least four pre-fabricated interlocking members. Each interlocking member also includes a lower segment wall and an upper segment wall. The lower segment wall extends in a first direction as well as a second direction perpendicular to the first direction. The upper and lower segments each have at least three edges with locking features for engagement with an adjacent interlocking member. The plurality of interlocking members surround and are secured to a post with a brick tie. The interlocking members include features on the at least three edges for locking engagement with an adjacent interlocking member.

### CROSS-REFERENCE TO RELATED APPLICATIONS

This application claims priority to U.S. Provisional Application No. 62/652,402 filed on Apr. 4, 2018, the entirety of which is incorporated herein by reference.

### FIELD OF THE DISCLOSURE

This disclosure relates in general to a kit for use in constructing an aesthetically appealing column with prefabricated stackable members that interlock with one another and are secured to a center post.

### BACKGROUND

The construction of masonry columns is a time consuming, skill intensive and an expensive process that requires many steps to accomplish. In order to construct a column the architect, or possibly the mason, must decide on the size of the brick column in order to calculate the amount of materials necessary to execute the construction event. Next, the bricks or stones must be wetted prior to the beginning of construction in order to prevent them from soaking up too much mortar. The base and apex of the column must be outlined on the ground surface and the ceiling prior to commencing building the column. Strings should preferably be strung from the base of the column to the top of the column where one of the corners will lie. This serves as the marker to make sure the brick or stone are being lined and spaced precisely; the corner of each brick should line up to the string line to ensure a straight construction.

Next, a thin layer of mortar, the ingredients of which must be carefully proportioned and mixed, is preferably smoothed out at the base of the column using a screed and the first layer of brick or stone is laid with sufficient joint space between each adjacent stone or brick. Each joint is then filled with mortar. Another layer of mortar is laid across the first brick course to create a top joint. These steps are repeated to achieve the desired height of the column. After every 2 or 3 joint layers are added, the joints must be concaved using a joint tool. The concave tool secures the mortar into place and allows proper water runoff from snow, rain and other elements. The concaving must be performed prior to the mortar drying and is no longer moldable. After concaving the mortar is brushed with a light whisk brush to smooth out the mortar.

The above description highlights in basic terms the complexity associated with constructing a stone or brick column and the need for a less costly, complicated and time-consuming method of doing so.

### SUMMARY

Disclosed herein is a kit for inexpensively, expeditiously and with limited masonry skills constructing a column of essentially any desired height around a post. These and other objects disclosed herein are achieved by providing a kit for constructing a stackable column. A preferred embodiment of the kit includes four pre-fabricated interlocking members. In the preferred embodiment four interlocking members are utilized to build each course, or layer, of the stackable column.

Each interlocking member is comprised of a lower segment wall and an upper segment wall. The upper segment wall is positioned atop the lower segment wall. The upper and lower segment walls each extend in a first direction as well as a second direction perpendicular to the first direction. The upper and lower segments each have at least three edges for engagement with an adjacent interlocking member. The interlocking engagement provides a seamless connection between the interlocking members and greatly diminishes any visually perceptible indication that a seam exists or that there are separate components joined together.

The interlocking members are preferably fabricated from a durable and color fade resistant concrete composition wherein the interlocking members have interior surfaces and exterior surfaces. The exterior concrete surface of each interlocking member is preferably fabricated with a faux stone appearance; however, a multitude of exterior finishes are also contemplated.

The kit disclosed herein also includes at least one panel of expanded polystyrene foam that is secured to the interior surfaces of the interlocking members by either an adhesive or with a shutter plug. In addition, a brick tie extends outwardly from at least one interior surface of each interlocking member. The flexible metal, or plastic, brick tie is secured to a post around which the four prefabricated interlocking members are positioned. The brick tie securing the interlocking member and specifically the expanded polystyrene foam against the center post. Both the upper and lower segment walls of the interlocking members include a locking feature to prevent slippage between adjacent interlocking members. The locking feature is preferably a tongue for engagement with a groove of an adjacent interlocking member.

An object of the kit disclosed herein is to eliminate the need for masonry skills when constructing a column.

A further object of the kit disclosed herein is to eliminate the need for the mixing of concrete.

A further object of the kit disclosed herein is to reduce the cost of constructing a column with a stone or brick exterior.

A further object of the kit disclosed herein is to reduce the amount of time required to construct a column with a stone or brick appearance.

These, together with other aspects of the disclosed technology, along with the various features of novelty that characterize the technology, are pointed out with particularity in the claims annexed hereto and form a part of this disclosed technology. For a better understanding of the disclosed technology, its operating advantages and the specific objects attained by its uses, reference should be made to the accompanying drawings and descriptive matter in which there are illustrated exemplary embodiments of the disclosed technology.

### BRIEF DESCRIPTION OF THE DRAWINGS

Illustrative embodiments of the disclosed technology are described in detail below with reference to the attached drawing figures, which are incorporated by reference herein and wherein:

FIG. 1 is a perspective view of an embodiment of an assembled stackable column kit;

FIG. 2 is a perspective view of an embodiment of the assembled stackable column kit detailing the engagement of the four interlocking members;

FIG. 3 is a perspective view of an embodiment of one interlocking member during the fabrication process detailing the attachment of the foam panel and the brick tie;

FIG. 4 is perspective view of an embodiment of the single interlocking panel detailing an embodiment of a locking feature;

FIG. 5 is a view of the top surface of an embodiment of the interlocking member; and

FIG. 6 is a perspective view of an embodiment of the interior surfaces of an interlocking member.

### DETAILED DESCRIPTION

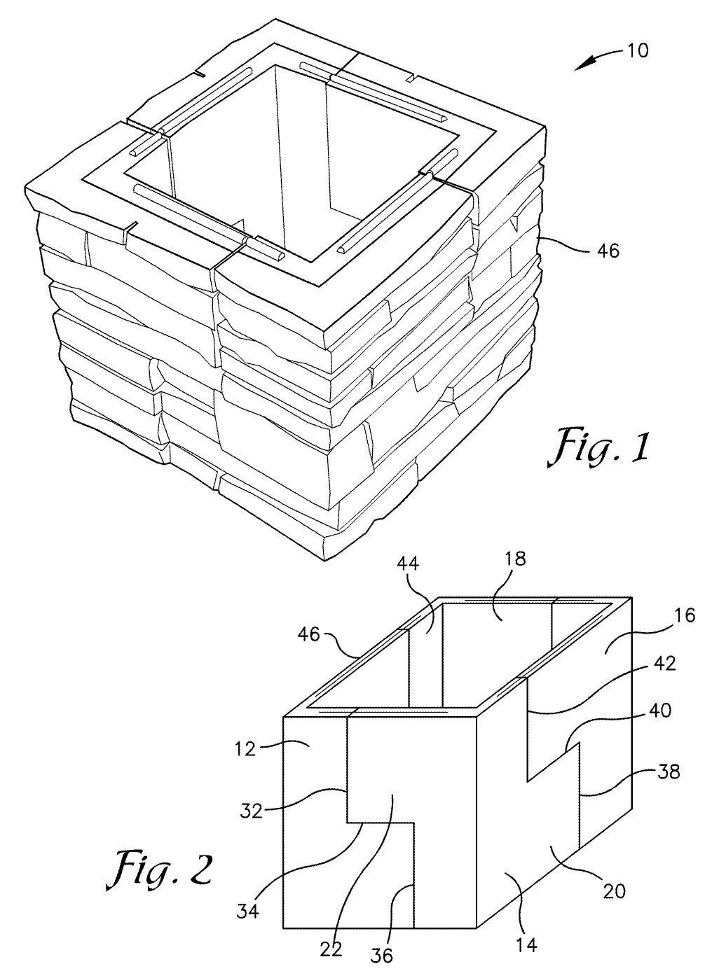

Disclosed herein and shown in FIG. 1 is a preferred embodiment of a kit 10 that includes four pre-fabricated interlocking members 12, 14, 16, 18. In the preferred embodiment of the kit 10, as seen in FIG. 2, four interlocking members are utilized to build each course, or layer, of the stackable column. Each interlocking member is comprised of a lower segment wall 20 and an upper segment wall 22. The upper segment wall 22 is positioned atop the lower segment wall 20. The upper and lower segment walls each extend in a first direction D1 as well as a second direction D2 perpendicular to the first direction D1. The upper and lower segments 22, 20 each have at least three edges 32-42 for engagement with an adjacent interlocking member. The interlocking engagement provides a solid connection between the interlocking members and greatly diminishes any visually perceptible indication that a seam exists or that there are separate components joined together.

The interlocking members 12-18 are preferably fabricated from a durable and color fade resistant concrete composition, the various formulations of which are well known in the industry. As shown in FIG. 2, the interlocking members include interior 44 and exterior 46 surfaces. The exterior concrete surface of each interlocking member is preferably fabricated with a faux stone 48 appearance as seen in FIG. 1; however, a multitude of exterior finishes are also contemplated.

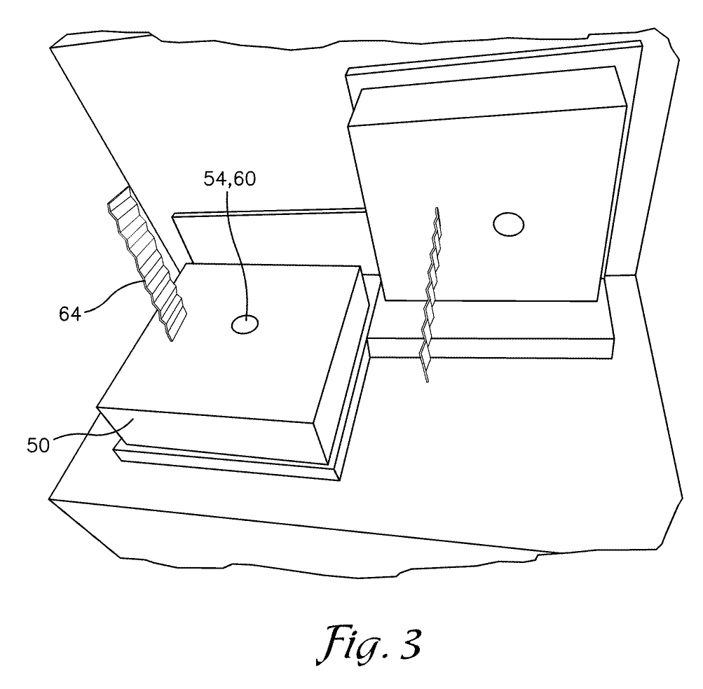

The kit 10 disclosed herein, as shown in FIG. 3 in a fabrication setting. The faux stone fabrication methodology is as described in U.S. Pat. No. 8,839,593 titled Pre-cast blocks for use in column construction. The fabrication methodology also includes at least one panel 50 of expanded polystyrene foam secured to the interior surfaces of the interlocking members by either an adhesive, or preferably with a shutter plug 54. If using a shutter plug 54, the shaft (not shown) of the shutter plug passes through the polystyrene foam panel 50 and into the concrete of the interlocking member while a wide head 60 rests atop the panel 50 securing it in position and minimizing the potential for the panel 50 being pulled away from the interior surface of the interlocking member.

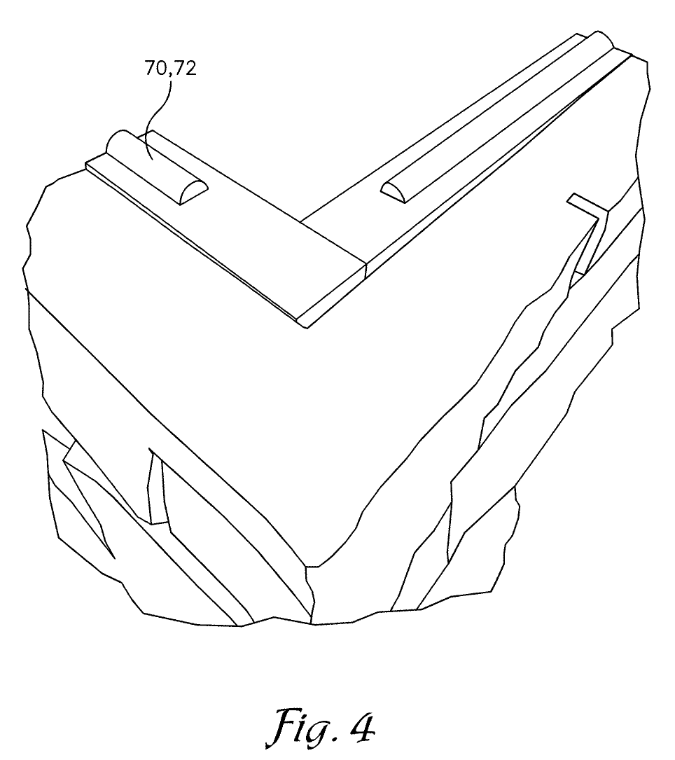

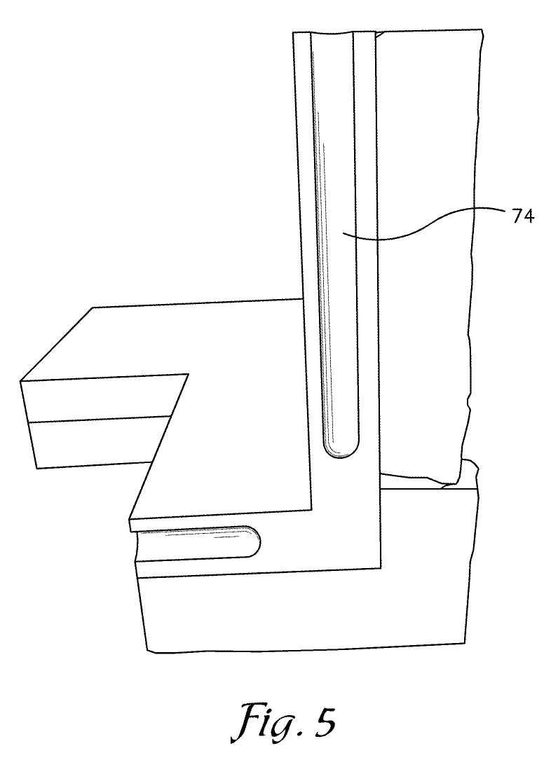

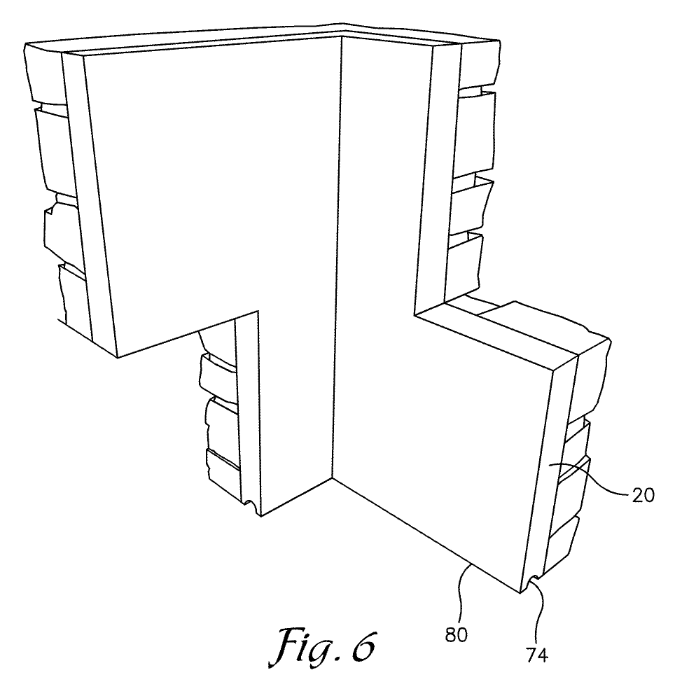

In addition, a brick tie 64 extends outwardly from at least one interior surface of each interlocking member. The flexible metal, or plastic, brick tie 64 is secured to a post (not shown) around which the four prefabricated interlocking members are positioned. The brick tie 64 secures the interlocking member and specifically the foam panel 50 against the center post (not shown). As seen in FIGS. 4 and 5, both the upper and lower segment walls 22, 20 of the interlocking members include a locking feature 70 to prevent slippage between adjacent interlocking members. The locking feature is preferably a tongue 72 for engagement with a groove 74 of an adjacent interlocking member.

The bottom edge 80 of the lower segment wall 20 is preferably configured with a groove 74 for accepting the tongue 72 of an interlocking member that is positioned beneath it. Also, should the interlocking member 12-18 be positioned at ground, as shown in FIG. 6, it can be positioned such that the bottom of the plurality of interlocking members rest upon the ground, or more precisely upon the concrete pad.

Should the plurality of interlocking members 12-18 of one course, or level, be stacked atop another course the tongue 72 of the lower course is received into the groove of the upper course. This engagement of the tongue 72 and groove 74 eliminates, or at least greatly diminishes, the prospect that an upper course will become disengaged from a lower course.

Should the full height of another course of the interlocking members 12-18 not be required to attain the desired ceiling height, the final course of interlocking members may be cut at the desired height for placement atop the column.

Many different arrangements of the various components depicted, as well as components not shown, are possible without departing from the spirit and scope of the disclosed technology. Embodiments of the disclosed technology have been described with the intent to be illustrative rather than restrictive. Alternative embodiments will become apparent to those skilled in the art that do not depart from its scope. A skilled artisan may develop alternative means of implementing the aforementioned improvements without departing from the scope of the disclosed technology.

It will be understood that certain features and sub combinations are of utility and may be employed without reference to other features and sub combinations and are contemplated within the scope of the claims. Not all steps listed in the various figures need be carried out in the specific order described.

We claim:

1. A kit for constructing a stackable column, the kit comprising;
at least four pre-fabricated interlocking members, each interlocking member further comprising a lower segment wall and an upper segment wall, the upper segment wall disposed atop the lower segment wall, the upper and lower segment walls each extending in a first direction as well as a second direction perpendicular to the first direction, the upper and lower segments each having at least three edges for engagement with an adjacent interlocking member.

2. The stackable column kit of claim 1, wherein the interlocking members are fabricated from a concrete composition.

3. The stackable column kit of claim 2, wherein the interlocking members have interior surfaces and exterior surfaces.

4. The stackable column kit of claim 3, wherein the exterior surface of each interlocking member is fabricated with a faux stone appearance.

5. The stackable column kit of claim 4, wherein at least one panel of expanded polystyrene foam is secured to the interior surfaces of the interlocking members.

6. The stackable column kit of claim 5, wherein the at least one panel of expanded polystyrene foam is adhesively secured to the interior surfaces.

7. The stackable column kit of claim 5, wherein the at least one panel of expanded polystyrene foam is secured to the interlocking member with a shutter plug.

8. The stackable column kit of claim 5, wherein a brick tie extends outwardly from at least one interior surface of each interlocking member.

9. The stackable column kit of claim 8, wherein the brick tie is securely anchored into an interior portion of the at least one interlocking member.

10. The stackable column kit of claim 8, wherein, in operation, the brick tie is secured to a post around which the at least four prefabricated interlocking members are positioned.

11. The stackable column kit of claim 1, wherein the at least three edges of the upper and lower segment walls of the interlocking members include a locking feature to facilitate alignment between adjacent interlocking members.

12. The stackable column kit of claim 11, wherein the locking feature further comprises a tongue for engagement with a groove of an adjacent interlocking member.

13. The stackable column kit of claim 1, wherein the interlocking members are fabricated from a concrete composition.
